(19) United States
(12) Patent Application Publication
(10) Pub. No.: US 2006/0190326 A1
(43) Pub. Date: Aug. 24, 2006

(54) Advertisement-purpose recordable optical disk, advertisement image forming method, and optical disk recording apparatus

(75) Inventors: Akihiko Suyama, Hamamatsu-shi (JP); Tamotsu Honma, Hamamatsu-shi (JP)

Correspondence Address: CROWELL & MORING LLP;INTELLECTUAL PROPERTY GROUP, P.O. BOX 14300, WASHINGTON, DC, 20044-4300, US

(73) Assignee: Yamaha Corporation, Hamamatsu-shi (JP)

(21) Appl. No.: 11/288,180

(22) Filed: Nov. 29, 2005

(30) Foreign Application Priority Data
Nov. 29, 2004 (JP) 2004-343256

(51) Int. Cl. G06Q 30/00

(52) U.S. Cl. 705/14

(57) ABSTRACT

In an optical disk, while restricting a program area which has been defined as to the normal disk and on which a user can record arbitrary information, a remaining area located outside this restricted program area is previously secured as an advertisement area where an advertisement-purpose visible image is formed. In the case that an advertisement-purpose recordable optical disk is loaded on an optical disk recording apparatus, the optical disk recording apparatus accesses via a pubic line network to an advertisement information distributing apparatus so as to acquire advertisement image information. Next, the optical disk recording apparatus irradiates an optical beam to the advertisement area in response to the acquired advertisement image information so as to reproduce the advertisement image.

### BACKGROUND OF THE INVENTION

The present invention is related to an advertisement-purpose recordable optical disk in which a portion of a program area defined in a regular optical disk is changed as an advertisement area used to form (draw) a visible image for advertisement (advertisement image). Further, the present invention is related to an advertisement image forming method for drawing an advertisement image on the advertisement-purpose recordable optical disk. Further, the present invention is related to an optical disk recording apparatus for performing an advertisement image forming method, by which advertisement images intended by distributors (advertisers etc.) of optical disks can be drawn.

A patent publication 1 discloses a technique for performing an image forming operation in such a manner that by executing a process operation for forming a mark (optically degenerative portion) in an information recording layer of a recordable optical disk such as a CD-R, the image is formed which is macroscopically viewed as either a character or a picture.

Patent Publication 1:

Japanese Patent Publication No. 2001-283470A1

The technical idea described in the patent publication 1 is to select an image to be drawn based upon an intention of a user of an optical disk, but cannot draw an advertisement-purpose image which is intended by a distributor of the optical disk. This technical idea is featured by that an image is formed in the remaining area after the user has recorded arbitrary information (user information). As a result, in such a case that a wide area is used to record the user information, there are some possibilities that such an area for forming an image is no longer secured.

### SUMMARY OF THE INVENTION

The present invention has been made to solve the above-explained problem, and therefore, has an object to provide an advertisement-purpose recordable optical disk, an advertisement-purpose forming method, and an optical disk recording apparatus, capable of drawing an advertisement image which is intended by a distributor of the optical disk.

An advertisement-purpose recordable optical disk of the present invention is characterized by that a program area where a user can record arbitrary information is restricted to a smaller range from a range defined as to the normal disk; and a remaining area located outside the restricted program area has been previously secured as an advertisement area where an advertisement-purpose visible image is formed. According to this optical disk, since the advertisement area is previously secured, such an advertisement image which is intended by a distributor of the optical disk can be drawn in this advertisement area.

In the advertisement-purpose recordable optical disk of the present invention, information indicative of a last possible start time of a lead-out area which is continued to a last possible start time of the restricted program area may been previously recorded. According to this optical disk, an optical disk recording apparatus may be set in order to avoid that the user information is recorded in the image area by utilizing the information indicative of the last possible start time of the lead-out area.

In the advertisement-purpose recordable optical disk of the present invention, a physical structure of a track which disturbs a continuous recording operation from the restricted program area to the advertisement area may be provided at a boundary portion between the restricted program area and the advertisement area. According to this optical disk, even when such an optical disk recording apparatus which is not operable in accordance with the present invention tries to continuously record the user information by neglecting the information indicative of the last possible start time of the lead-out area, it is possible to avoid that the user information is recorded in the advertisement area.

Further, in the advertisement-purpose recordable optical disk of the present invention, a code value represented by information indicative of the last possible start time of the lead-out area can be set to be smaller than, or equal to a code value which is represented by information indicative of the restricted program area, and can be recorded as a false code. According to this optical disk, an optical disk recording apparatus which is not operable to the present invention judges that the capacity of the program area is zero based upon the information indicative of the last possible start time of the false lead-out area, so that the user information cannot be recorded. To the contrary, since the information indicative of the last possible start time of the true lead-out area is recorded in combination with, for instance, identification information which is separately defined on this optical disk, such an optical disk recording apparatus operable in accordance with the present invention can acquire the information as to the last possible start time of the true lead-out area from the optical disk.

An advertisement image forming method, according to the present invention, is featured by that identification information for identifying as to whether or not a loaded optical disk corresponds to the advertisement-purpose recordable optical disk according to the present invention is read out from the loaded optical disk; a judgement is made as to whether or not the optical disk corresponds to the advertisement-purpose recordable optical disk according to the present invention based upon the identification information; in the case that the optical disk is judged to be equal to the advertisement-purpose recordable optical disk, a predetermined advertisement information distributing apparatus is accessed via a public line network, and advertisement image information used to form an advertisement as a visible image on the optical disk is acquired from the advertisement information distributing apparatus; and a light beam is applied onto the advertisement area secured in the optical disk so as to form an optically degenerative portion in an information recording layer of the advertisement area, and thus, the advertisement is represented as a visible image. According to the advertisement image forming method, the latest advertisement image which is intended by a distributor (advertiser etc.) of an optical disk can be recorded on the optical disk.

An optical disk recording apparatus, according to the present invention, executes a process operation as to the above-described advertisement image forming method of the present invention. In this case, in such a case that the identification information read from the loaded optical disk contains such an information for designating specific advertisement image information from a plurality of advertisement image information stored in the advertisement information distributing apparatus, the optical disk recording apparatus may be arranged by that the relevant advertisement image information is acquired from the advertisement information distributing apparatus based upon the information for designating the advertisement image information. According to this optical disk recording apparatus, advertisement images can be formed which are different from each other every optical disk, every firm, or every product.

Further, the optical disk recording apparatus of the present invention may be arranged in such a manner that until an advertisement in response to the advertisement image information acquired from the advertisement information distributing apparatus is represented as a visible image on the optical disk, a recording operation of the restricted program area is prohibited. As a result, the advertisement image can be firmly formed, and the advertisement effect can be firmly expected.

### BRIEF DESCRIPTION OF THE DRAWINGS

FIG. 1 is a flow chart describing controlling operation of an optical disk recording apparatus shown in FIG. 3 when an optical disk is loaded.

FIGS. 2A and 2B are diagrams representing an embodiment of an optical disk according to the present invention; FIG. 2A shows that areas of a normal CD-R disk are set; and FIG. 2B indicates that areas of a CD-R disk according to the present invention are set.

FIG. 3 is a block diagram indicating an embodiment of an optical disk recording apparatus of the present invention which is applied to the CD-R disk of FIG. 2B of the present invention.

FIG. 4 is a diagram indicating an advertisement image forming example according to the present invention.

FIG. 5 is a diagram for indicating track structures for the CD-R disk of FIG. 2B of the present invention, in which physical structures can disturbing continuous recording from a program area to an advertisement area.

### DETAILED DESCRIPTION OF THE PREFERRED EMBODIMENTS

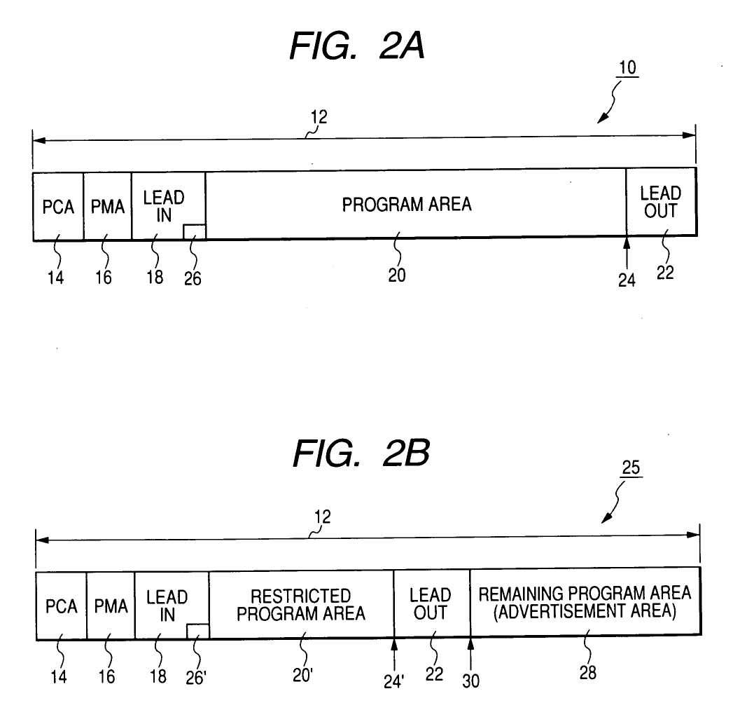

An embodiment according to the present invention will now be described. An embodiment of a recordable optical disk according to the present invention will be described. FIGS. 2A and 2B show a difference between an area setting condition of a normal CD-R disk 10 (see FIG. 2A) and an area setting condition of an advertisement-purpose CD-R disk 25 according to the present invention (see FIG. 2B). In the normal CD-R disk 10 as shown in FIG. 2A, a PCA area (Power Calibration Area) 14, a PMA area (Program Memory Area) 16, a lead-in area 18, a program area 20, and a lead-out area 22 are set from the inner circumferential side of this normal CD-R disk 10 in an information area (Information Area) 12. Lead-out area last possible start time information 26, and the like have been recorded in ATIP information of the lead-in area 18 as special information. This lead-out area last possible start time information 26 indicates a last possible start time 24 of the lead-in area 18 which corresponds to the next address of the last possible recording position of the program area 20. The program area 20 corresponds to such an area in which a user can record arbitrary information (user information). The lead-out area last possible start time information 26 is utilized as information by which program information cannot be recorded after the last possible start time information 26 of the lead-out area 22 in an optical disk recording apparatus (CD-R drive). Since the lead-out area 22 corresponds to such an area where information indicative of a lead-out subsequent to information recorded in the program area 20, the position of this lead-out area 22 varies, depending upon a used amount of the program area 20.

The advertisement-purpose CD-R disk 25 shown in FIG. 2B according to the present invention is set on the street, or the like, and is distributed to people in a free charge by a distributor such as an advertiser. The advertisement-purpose CR-D disk 25 is different from the normal CD-R disk 10 in that a last possible start time 24′ of a lead-out area 22 is restricted as a smaller time value (namely, position located closer to an inner circumference side) as compared with the last possible start time 24 of the lead-out area 22 of the normal CD-R disk. The above-described last possible start time 24′ of the lead-out area is indicated in last possible start time information 26′ of the lead-out area 22 which has been recorded in ATIP information of the lead-in area 18 of the advertisement-purpose CD-R disk 25. As a result, a capacity of a program area 20′ where the user can record arbitrary information has been restricted, as compared with the capacity of the program area 20 of the normal CD-R disk 10. Then, a remaining program area used to form an advertisement image has been secured as an advertisement area 28 on the outer circumferential side of the lead-out area 22. In other words, in this advertisement-purpose CD-R disk 25, such a program area 20′ used to record user information has been previously secured on the inner circumference side, and the advertisement area 28 used to form an advertisement image has been previously secured on the outer circumferential side. Alternatively, information as to a start time 30 (namely, advertisement area start time information) of the advertisement area 28 may be recorded in the ATIP information of the lead-in area 18 by employing an undefined code of the ATIP information.

In the case of the normal CD-R disk having a storage capacity of 650 MB, the last possible start time 24 of the lead-out area 22 of the normal CD-R disk having the diameter of 12 cm corresponds to 74 minutes 00 second 00 frame. In the case of the normal CD-R disk having a storage capacity of 700 MB, the last possible start time 24 of the lead-out area 22 of the normal CD-R disk having the diameter of 12 cm corresponds to 80 minutes 00 second 00 frame. In contrast to the normal CD-R disk, in accordance with the advertisement-purpose CD-R disk 25 of the present invention, if the last possible start time 24′ of the lead-in area 18 is set to, for instance, 42 minutes 00 second 00 frame, the entire area of this advertisement purpose CD-R disk 25 is subdivided into a program area 20′ having radiuses from 25 mm up to 42 mm in maximum, and a lead-out area 22 up to 42.62 mm outside this program area 20′; and an advertisement area 28 for forming an advertisement image defined from 42.62 mm up to 59 mm, so that this program area 20′ may be reduced by approximately ½, as compared with that of the normal CD-R disk. In other words, the last possible start time 24′ of the advertisement-purpose CD-R disk 25 is set to such a value which is smaller than the minimum last possible start time of the lead-out area 18 defined in the normal optical disk having a predetermined diameter.

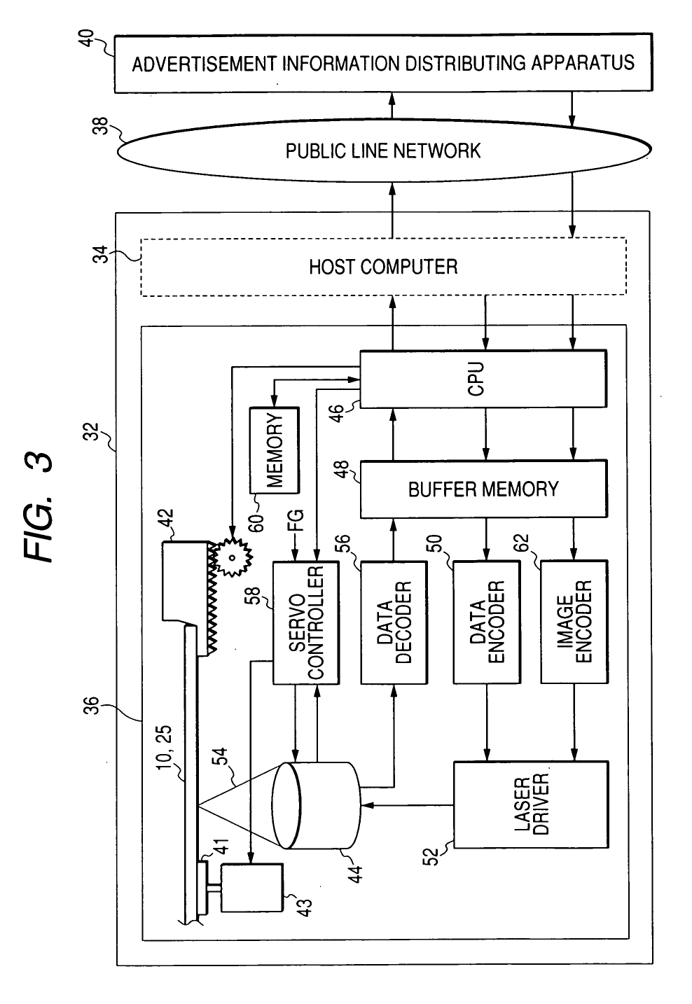

FIG. 3 shows an optical disk recording apparatus 32 according to the embodiment of the present invention, by which user information is recorded/reproduced and an advertisement image is formed on the advertisement-purpose CD-R disk 25 shown in FIG. 2B. That is, the optical disk recording apparatus 32 can record and reproduce the normal CD-R disk 10, and the advertisement-purpose CD-R disk 25 of the present invention as well as can form an advertisement image of the advertisement-purpose CD-R disk 25. The optical disk recording apparatus 32 is arranged as a sole apparatus, or is arranged in combination with a host computer (personal computer etc.) 34, and an optical disk drive (CD-R drive) 36. The optical disk recording apparatus 32 has been connected via a public line network 38 such as a telephone line to the Internet so as to be connected to an advertisement information distributing apparatus 40 which corresponds to a server of advertisement image information.

In the optical disk drive 36, the CD-R disk 10 (otherwise, CD-R disk 25) is loaded (guided) to and unloaded (ejected) from the optical disk drive 36 by a loading/unloading mechanism 42. The CD-R disk 10 (or disk 25) is mounted on a turn table 41, and is rotary driven by a spindle motor 43. User information is recorded and/or reproduced and an advertisement image is formed by an optical pickup 44. Application software has been stored in a memory 60 so as to perform an operation of forming an advertisement image. URL (Uniform Resource Locator) information indicative of an address of the advertisement information distributing apparatus 40 has been contained in this application software. This application software is initiated when the optical disk recording apparatus 32 judges that the advertisement-purpose CD-R disk 25 is loaded on the optical disk drive 36.

To record the user information, the user information which is supplied from the host computer 34 to the optical disk drive 36 is temporarily stored via the CPU 46 to a buffer memory 48, and the stored user information is encoded by an encoder 50, and then, the encoded user information is supplied to a laser driver 52. The laser driver 52 drives a laser source contained in the optical pickup 44 in response to code information of the supplied user information, and modulates laser light 54 so as to record this supplied user information on an information recording layer (coloring matter layer) of the program area 20(20′) of the CD-R disk 10(25). To reproduce the user information, laser light 54 having reproducing power is emitted from the optical pickup 44, and applied onto an information recording layer of the program area 20(20′) of the CD-R disk 10 (25). At this time, light returned from the CD-R disk 10 (25) is received by the optical pickup 44, this received light is decoded by a data decoder 56, and the decoded data is temporarily stored in the buffer memory 48, and then, the stored data is transferred via a CPU 46 to a host computer 34. A servo controller 58 performs a rotation control operation of the spindle motor 43, and both a focusing control operation and a tracking control operation for the optical pickup 44 when the user information is recorded and/or reproduced.

To form an advertisement image, image information (advertisement image information) of the advertisement image is sent out from the advertisement information distributing apparatus 40, and then, is supplied (downloaded) via the public line network 38 to the optical disk recording apparatus 32. The optical disk recording apparatus 32 transmits the downloaded image information via the host computer 34 to the optical disk drive 36. The advertisement image information transmitted to the optical disk drive 36 is temporarily stored via the CPU 46 into the buffer memory 48, and the stored advertisement information is decoded by an image encoder 62. The decoded advertisement image information is supplied to the laser driver 52. The laser driver 52 drives the laser source built in the optical pickup 44 and modulates the laser light 54 in response to the supplied advertisement image information so as to record the received advertisement image information on the information recording layer of the advertisement area 28 of the CD-R disk 25. The operation for recording an advertisement image information is performed in such a manner that marks (optically degenerative portions) are formed in the information recording layer of the advertisement area 28 so that if these marks are macroscopically viewed, then these marks become images such as characters, or pictures, and thus, a visible image is drawn to be formed. At this time, the servo controller 58 performs a rotation control operation of the spindle motor 43, and both a focusing control operation and a tracking control operation for the optical pickup 44. The rotation control operation of the spindle motor 43 at the time the advertisement image is formed is carried out as a constant rotation velocity bused upon an output of an FG (Frequency Generator) of the spindle motor 43.

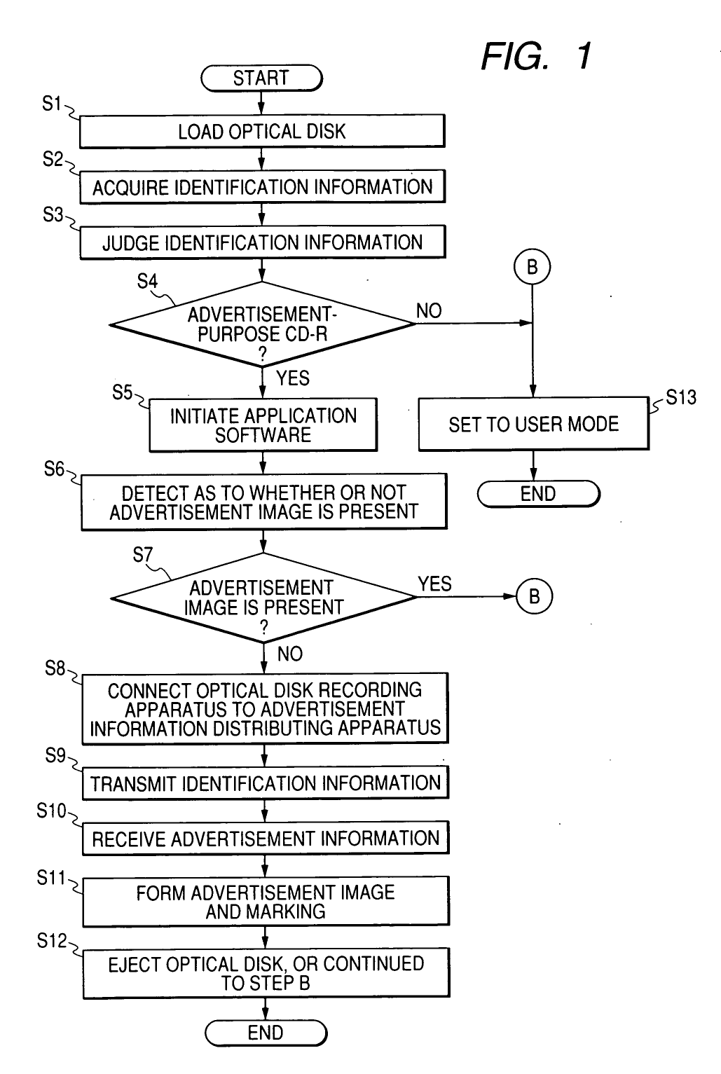

Referring now to a flow chart of FIG. 1, a description is made of control operations of the optical disk recording apparatus 32 when an optical disk loading operation is carried out. When the CD-R disk 10(25) is loaded on the optical disk drive 36 (step S1), the information of the lead-in area 18 of the CD-R disk 10(25) is read out from the disk. The CPU 46 of the optical disk recording apparatus 32 checks the lead-out area last possible start time information 26(26′) indicative of the last possible start time 24(24′) of the lead-out area 22, which is contained in the ATIP information as identification information for identifying as to whether or not this loaded disk corresponds to the normal CD-R disk 10, or the advertisement-purpose CD-R disk 25 based upon the read information (step S2). In the case that the CPU 46 judges the read identification information (lead-out area last possible start time information 26, (26′)) in a step S3. If this judged identification information corresponds to either “74 minutes 00 second 00 frame” or “80 minutes 00 second 00 frame”, the CPU 46 judges that the loaded disk corresponds to the normal CD-R disk 10 (step S4), and then, the operation mode of the optical disk recording apparatus 32 is advanced to a user mode (step S13) so as to be set to such a condition that the user can record, or reproduce arbitrary program information on/from this loaded disk.

In the case that the read identification (namely, lead-out area last possible start time information) corresponds to such an information (for instance, “42 minutes 00 second 00 frame”) which is defined for the advertisement-purpose CD-R disk 25, the CPU 46 judges that the loaded disk corresponds to the advertisement-purpose CD-R disk 25 (step S4), so that operation for recording the arbitrary program information by the user mode (step S13) is prohibited. Then, the application software for forming the advertisement image is initiated (step S5). When this application software is initiated, the CPU 46 firstly checks as to whether or not an advertisement image has already been formed on the CD-R disk 25 (step S6). This checking operation can be carried out by scanning, for example, the advertisement area 28 to detect as to whether or not an RF signal is present. If the RF signal is present, the CPU 46 judges that the advertisement image has already been formed (step S7), and then, the operation mode is advanced to the user mode (step S13) so as to be brought into such a condition that the user can record the arbitrary program information. Alternatively, in the case that it is so determined that when an advertisement image is formed, such a marking for indicating that the advertisement image has already been formed is recorded at a predetermined position of an optical disk, then the CPU 46 detects as to whether or not this marking is present. The predetermined position corresponds to, for example, a position between the lead-in area 18 and the PMA area 16, a position on the inner circumferential side from the PCA area 14, a position on the inner circumferential side, or outer circumferential side from the advertisement area 28, or the like. If this marking is present, the CPU 46 judges that the advertisement image has already been formed (step S7), and thus, the operation mode is advanced to the user mode (step S13), so that the optical disk recording apparatus 32 may be set to such a condition that the user can record arbitrary program information.

In the case that the RF signal is not present in the advertisement area 28, or the marking for indicating that the advertisement image has been formed is not present at the predetermined position, the CPU 46 judges that the advertisement image has not yet been formed, and thus, connects the optical disk recording apparatus 32 to the advertisement information distributing apparatus 40 based upon the URL information which indicates the address of the advertisement distributing apparatus 40 and is contained in the application software (step S8). Then, the CPU 46 transmits the read identification information (for example, “42 minutes 00 second 00 frame”) to the advertisement information distributing apparatus 40 (step S9). The advertisement information distributing apparatus 40 transmits advertisement image information corresponding to this identification information to the optical disk recording apparatus 32. The optical disk recording apparatus 32 receives this advertisement information (step S10), and then, forms the corresponding advertisement image in the advertisement area 28 of the CD-R disk 25 (step S11). It should also be noted that when the advertisement area starting position information has been recorded in the ATIP information of the lead-in area 18 by employing an undefined code of the ATIP information, a starting position of the advertisement area 28 is designated based upon this advertisement area starting position information. In such a case that the advertisement area starting position information is not recorded, the CPU 46 may alternatively calculate such a position by adding the defined capacity (namely, at least minimum recordable time of 1.5 minutes by width of 1.0 mm along radial direction) of the lead-out area 22 to the last possible start time 24′ of the lead-out area 22, and then, may alternatively designate the calculated position as the advertisement area starting position. As previously explained, after the optical disk recording apparatus 32 has been connected to the advertisement distributing apparatus 40, the identification information is transmitted from the optical disk recording apparatus 32. Instead of this operation, while a plurality of advertisement information to which a plurality of identification information have been attached are distributed at random from the advertisement information distributing apparatus 40, the optical disk recording apparatus 32 may acquire such an advertisement image information corresponding to the read identification information (step S10), and then, may form the corresponding advertisement image (step S11). In this alternative case, the above-described step S9 may be skipped.

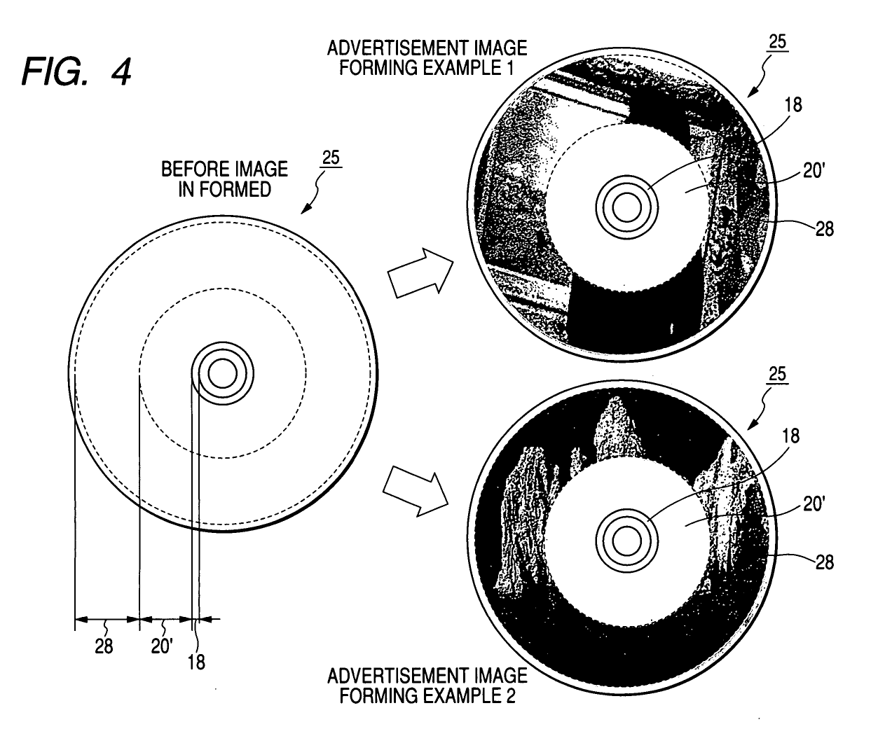

In such a case that it is so determined that the marking for indicating that an advertisement image has been formed should be recorded at a predetermined position after the advertisement image has been formed, the CPU 46 marks at the predetermined position. Thereafter, the CD-R disk 25 is unloaded (step S12). As a result, for example, as indicated as an advertisement image forming example 1, or 2 in FIG. 4, the CD-R disk 25 where the advertisement image has been formed in the advertisement region 28 is obtained. If the CD-R disk 25 where the advertisement image has been formed is again loaded on the optical disk recording apparatus 32, then the operation mode thereof is advanced to the user mode of FIG. 1 (step S13), and thus, arbitrary user information can be recorded in the program area 20′. Alternatively, after the advertisement image has been formed (step S11), the operation mode may be continuously advanced to the user mode without unloading the CD-R disk 25 (step S13), and then, the user information may be recorded in the program area 20′. The CD-R 25 where the user information has been recorded may be loaded on this optical disk recording apparatus 25 so as to reproduce this recorded user information, or may be loaded on the normal CD-R drive which cannot be operated in the mode of the present invention so as to reproduce this user information.

Alternatively, a plurality of advertisement information can be prepared in the advertisement information distributing apparatus 40, and advertisement images which are different in response to optical disks can be formed. For instance, this alternative case may be realized by recording frame values which are different in response to optical disks as identification information for identifying as to whether or not the loaded disk is an advertisement-purpose CD-R disk. In other words, as the above-described identification information (lead-out area last possible start time information 26′), for example,
advertiser firm “A”: “42 minutes 00 second 00 frame”,
advertiser firm “B”: “42 minutes 00 second 01 frame”,
advertiser firm “C”: “42 minutes 00 second 02 frames,”
   ---, have been allocated to be recorded with respect to each of the advertiser firm “A”, the advertiser firm “B”, and the advertiser firm “C”, ---, and a plurality of advertisement image information responding to these identification information have been prepared in the advertisement information distributing apparatus 40. With employment of this preparation of the advertisement image information when such an identification information read out from the CD-R disk 25 is transmitted from the optical disk recording apparatus 32 (step S9), the advertisement information distributing apparatus 40 can select advertisement image information of the corresponding advertiser firm in accordance with this transmitted identification information, and may transmit the selected advertisement image information to the optical disk recording apparatus 32. Then, the optical recording/reproducing apparatus 32 can receive this advertisement image information (step S10), and can record the corresponding advertisement image on the CD-R disk 25 (step S11). Alternatively, such identification information (lead-out area last possible start time information 26′) which are different from respective different products of the same advertiser firm may be allocated.

In the case that the frame values are recorded which are different from each other in response to the optical disks, such an identification for identifying as to whether or not the loaded disk is the advertisement-purpose CD-R disk may be carried out based upon such values obtained by excluding the frame values (for instance, “42 minutes 00 second”). Alternatively, instead of differing of the lead-out area last possible start time information, such an information for designating advertisement images different form each other in response to optical disks may be alternatively recorded by employing the undefined codes of the ATIP information.

In accordance with the control operation of FIG. 1, as to the advertisement CD-R disk 25, the user information cannot be recorded in the program area 20′ unless the advertisement image has already been formed in the advertisement area 28. As a result, the advertisement effect can be firmly expected.

Incidentally, the above-explained advertisement-purpose CD-R disk 25 is loaded on the optical disk recording apparatus which does not have a function of forming advertisement image according to the present invention, the user information can be recorded up to 1 address (for example, 41 minutes 59 seconds 74 frames) before such a position (for instance, 42 minutes 00 second 00 frame) which is recorded as the lead-out area last possible start time position 241. Next, a description is made of an example of measurements for prohibiting such a use. That is, in the advertisement-purpose CD-R disk 25 shown in FIG. 2B according to the present invention, as the lead-out area last possible start time information 26′ which is recorded in the ATIP information of the lead-in area 18, such a false information as “00 minute 00 second 00 frame” and a negative address value is recorded. Then, information as to the true last possible start time position 24′ of the lead-out area 22 is recorded in the lead-in area 18 by employing the undefined code of the ATIP information. As a result, when this advertisement-purpose CD-R disk 25 is loaded on an optical disk recording apparatus not operable in accordance with the present invention, this optical disk recording apparatus judges that the capacity of the program area 20′ is equal to zero. As a result, the recording operation of the user information is prohibited. In contrast, in accordance with the optical disk recording apparatus of the present invention, since the above-described undefined code is defined, the true information of the last possible start position 24′ of the lead-out area 22 may be acquired from the ATIP information of the lead-in area 18, so that the user information can be recorded.

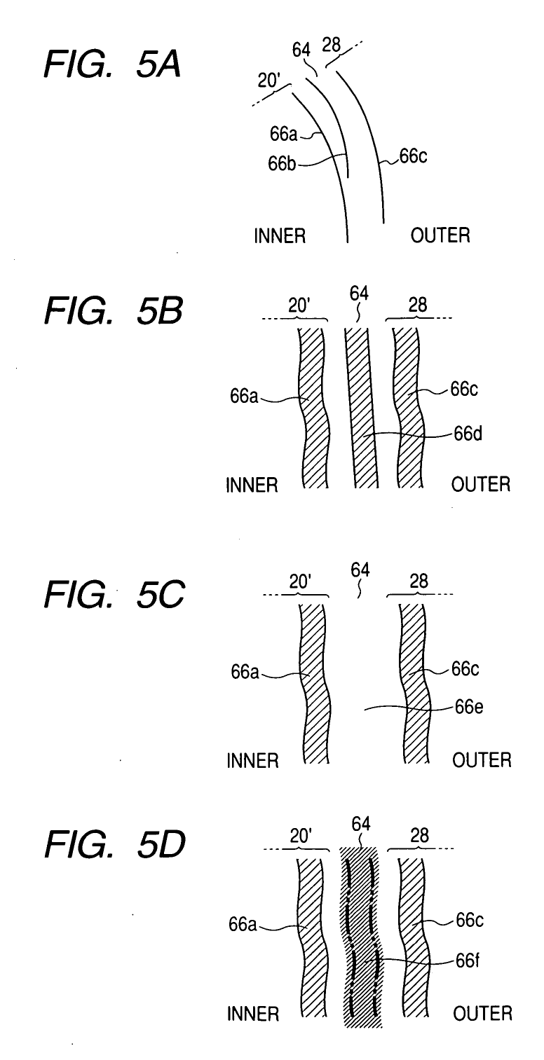

Furthermore, a description is made of measures against an optical disk recording apparatus capable of recording, while neglecting the lead-out area last possible start time information 26′ recorded in the ATIP information of the lead-in area 18. That is, in the advertisement-purpose CD-R disk 25 shown in FIG. 2B according to the present invention, as indicated in FIG. 5, physical structures of tracks for disturbing continuous recording from the program area 20′ to the advertisement area 28 are formed at a boundary portion between the program area 20′ and the advertisement area 28. These physical structures have been constructed in order to physically block recording to the advertisement area 28. That is, an example of FIG. 5A indicates a permanent retention structure, namely, a track end portion 66b of the program area 20′ has been formed and directed toward the track 66a of the inner circumferential side at a boundary portion 64 between the program area 20′ and the advertisement area 28. If a recording position is reached to the end portion 66b of the program area 20′ and a further continuous recording operation is tried to be performed, the recording position is returned to the preceding circumference 66a, so that the recording position is not entered into the advertisement area 28. Although the operation is carried out for a moment, since an address is not increased, an error occurs, so that the optical disk recording apparatus is stopped.

As to an example shown in FIG. 5B, a track 66d without a clock mark (wobbling mark) has been formed at the boundary portion 64 between the program area 20′ and the advertisement area 28. In this example, although a tracking control is available, since a signal used to acquire a reference clock cannot be detected, either a rotation control operation or a recording signal producing process operation cannot be practically carried out. As a result, an error occurs, so that the optical disk recording apparatus is stopped.

As to an example of FIG. 5C, a portion without a track (namely, trackless track 66e) has been formed in the boundary portion 64 between the program area 20′ and the advertisement area 28. In this case, an error occurs, so that the optical disk recording apparatus is stopped.

As to an example of FIG. 5D, a track 66f which had been formed in the boundary portion 64 between the program area 20′ and the advertisement area 28 is crushed by applying strong laser light onto this track 66f before the optical disk is distributed. The crushed portion owns a low reflectance factor, and an equivalent effect to that of the above-explained trackless track 66e can be achieved. As a result, an error occurs, so that the optical disk recording apparatus is stopped.

Even in such a case that the physical structures of the tracks as shown in FIGS. 5A to 5D are formed, by providing the optical disk recording apparatus of the present invention with such a function capable of seeking a predetermined advertisement area start position of the advertisement area 28 by way of a track jumping manner, then this optical disk recording apparatus can jump over the track disturbance portions 66b, 66d, 66e and can be reached to the advertisement area starting position so as to form an advertisement image.

The above-described embodiment has explained such a case that the present invention is applied to the CD-R system. Alternatively, the present invention may be alternatively applied to other recordable type CD systems (CD-RW) etc.), recordable type DVD systems (DVD-R, DVD-R, DVD-RW, DED-RW, DVD-RAM etc.), and other recordable type optical systems.

Further, in the above-explained embodiment, “42 minutes 00 second 00 frame” has been exemplified as the lead-out area last possible start time information 26′. This is an example which has employed a value smaller than that of the normal disk of 12 cm, and is larger than that of the normal disk of 8 cm. Alternatively, when a smaller value is employed, the lead-out area last possible start time information may be selected by from an area except an area in the vicinity of approximately 20 minutes of the 8 cm-disk, or approximately 5 minutes of a card type disk. In other words, this position information is set to a value indicative of such a position between the respective lead-out area last possible start time information of the respective optical disks having the respective diameters. Alternatively, while a reflection light detecting method is utilized, either a dimension check or a shape check may be combined therewith.

1. An advertisement-purpose recordable type optical disk comprising:
a program area where a user can record arbitrary information and which is restricted to a smaller range from a range defined as to a normal disk; and
an advertisement area where an advertisement-purpose visible image is formed and which is a remaining area located outside the restricted program area which is previously secured.

2. The advertisement-purpose recordable optical disk according to claim 1, wherein information indicative of a last possible start time of a lead-out area which is continued to a last possible start time of the program area is previously recorded in the optical disk.

3. The advertisement-purpose recordable optical disk according to claim 2, wherein a code value represented by information indicative of the last possible start time of the lead-out area is smaller than, or equal to a code value which is represented by information indicative of the program area.

4. The advertisement-purpose recordable optical disk according to claim 1, wherein a physical structure of a track which disturbs a continuous recording operation from the program area to the advertisement area is provided at a boundary portion between the program area and the advertisement area.

5. The advertisement-purpose recordable optical disk according to claim 1, wherein the program area and the advertisement area are information recording layer which is discolored by a light beam.

6. A method of forming an advertisement image on a loaded optical disk, the method comprising:
reading out, from the loaded optical disk, identification information for identifying as to whether or not the loaded optical disk corresponds to an advertisement-purpose recordable optical disk according to claim 1;
judging as to whether or not the optical disk corresponds to the advertisement-purpose recordable optical disk based on the identification information;
accessing a predetermined advertisement information distributing apparatus via a network, and acquiring advertisement image information used to form an advertisement as a visible image on the optical disk from the advertisement information distributing apparatus when the loaded optical disk is judged to correspond to the advertisement-purpose recordable optical disk; and
applying a light beam onto an advertisement area in the advertisement-purpose recordable optical disk so as to form the advertisement as a visible image on the advertisement-purpose recordable optical disk.

7. An optical disk recording apparatus for forming an advertisement image on a loaded optical disk, the optical disk recording apparatus comprising:
a controller that controls a process operation so as to:
read out, from the loaded optical disk, identification information for identifying as to whether or not the loaded optical disk corresponds to an advertisement-purpose recordable optical disk according to claim 1;
judge as to whether or not the optical disk corresponds to the advertisement-purpose recordable optical disk based on the identification information;
access a predetermined advertisement information distributing apparatus via a network, and acquire advertisement image information used to form an advertisement as a visible image on the optical disk from the advertisement information distributing apparatus when the loaded optical disk is judged to correspond to the advertisement-purpose recordable optical disk; and
apply a light beam onto an advertisement area in the advertisement-purpose recordable optical disk so as to form the advertisement as a visible image on the advertisement-purpose recordable optical disk.

8. The optical disk recording apparatus according to claim 7, wherein
the identification information contains information for designating specific advertisement information from a plurality of advertisement image information stored in the advertisement information distributing apparatus, and
the advertisement image information is acquired from the advertisement information distributing apparatus based on the information for designating the advertisement image information.

9. The optical disk recording apparatus according to claim 7, wherein a recording operation of the restricted program area is prohibited until the advertisement in response to the advertisement image information acquired from the advertisement information distributing apparatus is represented as the visible image on the optical disk.
